(19) United States
(12) Patent Application Publication
(10) Pub. No.: US 2021/0390079 A1
(43) Pub. Date: Dec. 16, 2021

(54) SEARCH CAPACITY FOR LOCAL AND/OR REMOTE DOCKER SUB-SYSTEMS

(71) Applicant: EMC IP Holding Company LLC, Hopkiton, MA (US)

(72) Inventor: Robert Ballantyne, Mansfield, MA (US)

(73) Assignee: EMC IP Holding Company LLC, Hopkinton, MA (US)

(21) Appl. No.: 16/899,655

(22) Filed: Jun. 12, 2020

(51) Int. Cl. G06F 16/11; G06F 16/14; G06F 16/16; G06F 9/54

(52) U.S. Cl. CPC G06F 16/128; G06F 16/144; G06F 9/54; G06F 16/168; G06F 16/156

(57) ABSTRACT

A method is used in searching a docker system to understand the objects therein. An application executing on a computer system creates a snapshot of the docker system. The application receives search criteria for objects in the docker system. The application generates a recursive search based on the search criteria. The application applies the recursive search to the snapshot of the docker system. The application displays results of the recursive search.

### BACKGROUND

### Technical Field

This application relates to searching local and/or remote docker sub-systems to understand the relationships between the objects therein.

### Description of Related Art

Docker subsystems include many objects, such as containers, images, networks, volumes, clients, and configurations. Each object is uniquely identified by a name and/or other identifier, and each object has attributes and links with other objects. Objects can be cross referenced within a docker subsystem. Furthermore, a local docker subsystem can connect to one or more remote docker subsystems over a computer network, such that the objects within the local docker subsystem are linked with objects in the remote docker subsystems.

An image of a docker system may be built from layers, and each layer can include other images. When a docker system includes multiple layers, identifying objects based on their own attributes or attributes shared with other objects is cumbersome, as is identifying objects according to the nature of their relationships with one another.

### SUMMARY OF THE INVENTION

One aspect of the current technique is a method for use in searching a docker system to understand the objects therein. The method includes creating, by an application executing on a computer system, a snapshot of the docker system. The method also includes receiving search criteria for objects in the docker system. The method also includes generating a recursive search based on the search criteria. The method also includes applying the recursive search to the snapshot of the docker system. The method also includes displaying results of the recursive search.

The method may include requesting information about objects in a local docker subsystem. The method may include requesting information about objects in a remote docker subsystem and creating the snapshot from the information about the objects in the local and remote docker subsystems. In some embodiments, the method includes requesting, via an application programming interface provided by a docker subsystem, information about the objects in the docker subsystem.

The method may include receiving the search criteria as plain text or a regular expression. The method may include generating a recursive search for a type of object that meets the search criteria. The method may include applying the recursive search to different types of objects in the docker system to identify a set of initial matches. The method may include cross-referencing each object in the set of initial matches to identify additional matches to the search criteria. The method may include evaluating objects related to each object in the set of initial matches according to the search criteria to find additional matches. The method may include traversing, for each object in the set of initial matches, a linked list of objects to compare each linked object to the search criteria.

Another aspect of the current technique is a system, with a processor, for use in managing inline data compression and deduplication in storage systems. The processor is configured to create a snapshot of the docker system, receive search criteria for objects in the docker system, generate a recursive search based on the search criteria, apply the recursive search to the snapshot of the docker system, and display results of the recursive search. The processor may be configured to perform any other processes in conformance with the aspect of the current technique described above.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 depicts an exemplary embodiment of a docker system to be searched by a search application, the docker system including a local docker subsystem and a remote docker subsystem connected over a computer network;

FIG. 2 depicts an exemplary embodiment of a local docker subsystem;

FIG. 3 depicts an exemplary embodiment of a computer system that executes the search application for searching the docker system;

FIG. 4 shows exemplary pseudo-code for creating a snapshot of a docker system;

FIG. 5 shows exemplary pseudo-code for searching objects to find an initial set of matches and evaluating related objects to find additional matches;

FIG. 6 shows exemplary pseudo-code for displaying results of a search through a docker system;

FIG. 7 shows exemplary pseudo-code for generating a recursive search based on a regular expression;

FIG. 8 shows exemplary pseudo-code for generating a recursive search based on plain text;

FIG. 9 depicts exemplary pseudo-code for finding additional search results by searching objects related to the objects in the initial set of matches;

FIGS. 10-14 show exemplary displays of information from searches of a docker system performed according to the techniques described herein; and

FIG. 15 depicts a flow diagram illustrating searching a docker system.

### DETAILED DESCRIPTION OF EMBODIMENT(S)

Described below is a technique for use in searching a docker system, which technique may be used to provide, among other things, creating, by an application executing on a computer system, a snapshot of the docker system; receiving search criteria for objects in the docker system; generating a recursive search based on the search criteria; applying the recursive search to the snapshot of the docker system; and displaying results of the recursive search.

To support the execution of applications, a docker system relies on a complex system of objects, such as clients, configurations, containers, images, networks, and volumes. A docker system may include docker subsystems, which may be local, remote, or a combination thereof. Local docker subsystems may connect to remote docker subsystems over one or more computer networks. This connectivity enables users to execute applications that use objects available on remote docker subsystems, in addition to objects that are locally available. In this manner, a robust, network-connected docker system greatly increases the resources that can be used by its users.

Developing such a docker system presents unique challenges arising from the relationships of its objects. As discussed above, objects have their own attributes and links to other objects, and an image of a docker system may be built from layers, each of which can include other images. Understanding of the nature of the objects and the relationships between them are difficult, but necessary, prerequisites for troubleshooting flaws, improving features, and expanding functionalities in a docker system. Existing docker inspection commands provide limited visibility into the docker system, thereby requiring a developer to issue successive commands to piece together his or her understanding of the objects in the system and the relationships between them.

In contrast, various embodiments of the current technique enable developers to understand the objects of a docker system in a more targeted and efficient manner. An application captures a snapshot of a docker system, including local and remote docker subsystems. The application accepts a command from the developer and formulates the corresponding recursive searches through the snapshot that would identify the objects and/or their relationships being requested by the developer. The application applies the searches to the snapshot and displays the results to the developer.

In at least some implementations in accordance with the techniques as described herein, providing search capacity for a docker system, such as a docker system with local and remote docker subsystems, can provide one or more of the following advantages: superior visibility of objects in a docker system and the relationships between them, a sophisticated yet efficient command interface for understanding the docker system, reduced downtime for repair, and faster development cycles for improving the docker system.

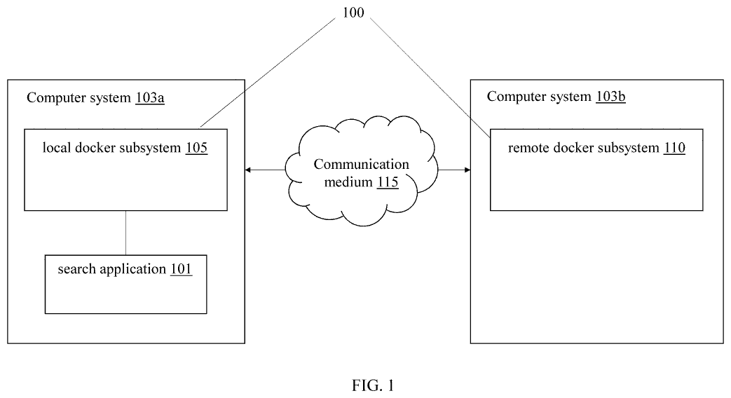

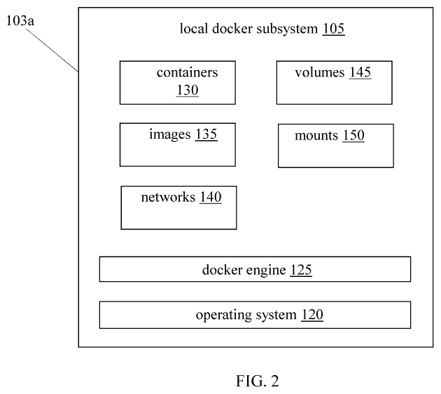

FIG. 1 depicts an exemplary embodiment of a docker system 100 to be searched by a search application 101 executing on a first computer system 103a. The docker system 100 includes a local docker subsystem 105 on the first computer system 103a and a remote docker subsystem 110 on a second computer system 103b, and FIG. 2 depicts an exemplary embodiment of a local docker subsystem 105, whose components may be included in any other docker subsystem. The computer system 103a hosting the local docker subsystem 105 executes an operating system 120 and a docker engine 125. Through the docker engine 125, the local docker subsystem 105 supports the containers 130, images 135, networks 140, volumes 145, and mounts 150 of the docker system 100.

The first and second computer systems 103, 107 are connected over a communication medium 115. Although the docker system 100 depicted in FIG. 1 includes a single local docker subsystem 105 and a single remote docker subsystem 110, in various embodiments, the docker system 100 may include multiple local docker subsystems 105a, 105b, . . . , 105n and/or multiple remote docker subsystems 110a, 110b, 110n, each of which resides on a computer system 103a, 103b, . . . , 103n connected to the communication medium 115.

The communication medium 115 may be any one or more of a variety of networks or other type of communication connections as known to those skilled in the art. The communication medium 115 may be any type of network or combination of networks, such as a storage area network (SAN), a local area network (LAN), a wide area network (WAN), the Internet, and/or some other type of network or combination of networks, for example. The communication medium 115 may include one or more network connections, buses, and/or other types of data links, such as a hardwire or other connections known in the art. For example, the communication medium 115 may be the Internet, an intranet, network or other wireless or other hardwired connection(s) by which the computer systems 103, 107 may access and communicate with one another. In one embodiment, the communication medium 115 may be a LAN connection, an iSCSI, Fibre Channel, Serial Attached SCSI, Fibre Channel over Ethernet connection, NFS, SMB 3.0, or CIFS.

Any of the docker subsystems 105, 110 can signal its availability, either to its corresponding computer system 103 or to other docker subsystems 105, 110 by exposing its application programming interface (API). In some embodiments, the API may be a Representational State Transfer (REST) API, and the API may be exposed on port 4243 of the computer system 103.

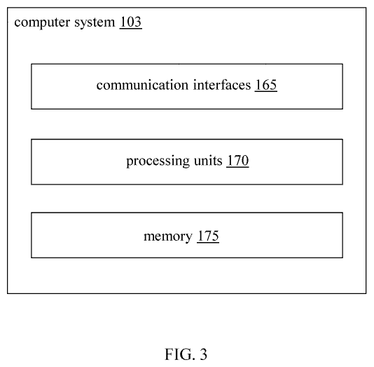

FIG. 3 shows a block diagram of an exemplary computer system 103 that executes the search application 101. The computer system 103 includes one or more communication interfaces 165, a set of processing units 170, and memory 175. The communication interfaces 165 may be provided for converting electronic and/or optical signals received over the communication medium 115 to electronic form for use by the processing units 170. The set of processing units 170 includes one or more processing chips and/or assemblies, and may include multi-core CPUs.

The memory 175 includes both volatile memory (e.g., RAM), and non-volatile memory, such as one or more ROMs, disk drives, solid state drives, and the like. The set of processing units 170 and the memory 175 together form control circuitry, which is constructed and arranged to carry out various methods and functions as described herein. Also, the memory 175 includes a variety of software constructs realized in the form of executable instructions. When the executable instructions are run by the set of processing units 170, the set of processing units 170 are caused to carry out the operations of the software constructs. Although certain software constructs are specifically shown and described, it is understood that the memory 175 typically includes many other software constructs, which are not shown, such as an operating system, various applications, processes, and daemons.

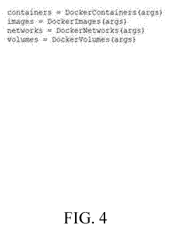

To provide search capacity for the docker system 100, the search application 101 first creates a snapshot of the docker system 100. The search application 101 obtains information about the objects, their attributes, and their relationships from all of the docker subsystems 105, 110, whether they are local or remote. In some embodiments, the search application 101 executes a script to retrieve information about the containers 130, images 135, networks 140, volumes 145, and mounts 150 of each docker subsystem 105, 110. The script may send requests to the REST APIs of each subsystem 105, 110 in the docker system 100. The search application 101 combines the results from the requests to produce a snapshot of the docker system 100. Exemplary pseudo-code for creating a snapshot of the docker system 100 is shown in FIG. 4.

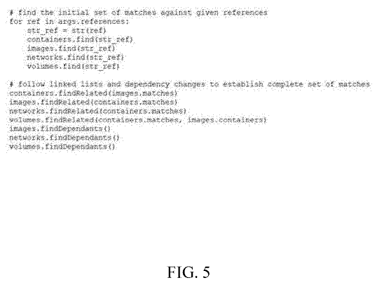

The search application 101 is configured to receive a search request from a user. In some embodiments, the search request is expressed as plain text to be matched, and in other embodiments, the request is expressed as a regular expression (e.g., regex). From the request, the search application 101 generates a recursive search to apply to the docker system 100 snapshot. The search application 101 applies the recursive search to the objects themselves to obtain an initial set of matches. Then, the search application 101 cross references the initial set of matches with other objects in the snapshot to obtain a complete set of matches. In particular, for each object in the initial set of matches, the search application 101 evaluates related objects to identify more objects that fulfill the user's search request. In some embodiments, an object includes a linked list that identifies related objects. The search application 101 may traverse an object's linked list, applying the search criteria to each object identified therein, to find additional matches. Exemplary pseudo-code for searching objects to find an initial set of matches and evaluating related objects to find additional matches is shown in FIG. 5.

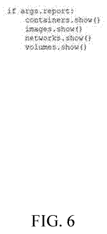

The search application 101 displays the results to the user. In some embodiments, the display includes flags that enable the user to filter, or expand, the amount of detail shown for each search result. Exemplary pseudo-code for displaying the objects found in the search is shown in FIG. 6.

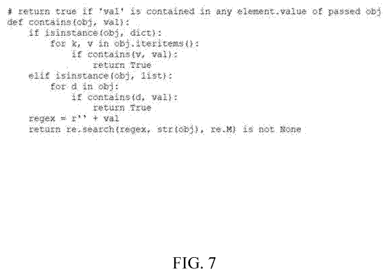

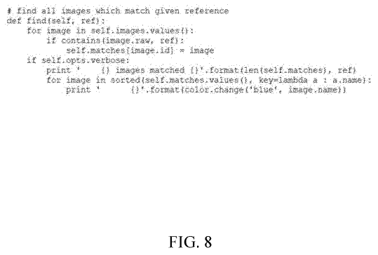

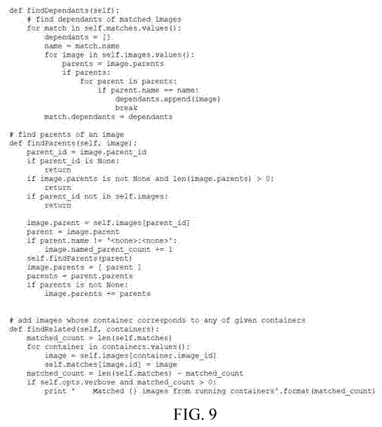

FIG. 7 shows exemplary pseudo-code for generating a recursive search based on a regular expression. The pseudo-code may be applied to any type of object. FIG. 8 shows exemplary pseudo-code for generating a recursive search based on plain text. The embodiment in the figure concerns images, but similar pseudo-code may be created to search other types of objects, such as containers, volumes, and networks. FIG. 9 depicts exemplary pseudo-code for finding additional search results by searching objects related to the objects in the initial set of matches.

In one example, the docker system 100 includes more than one hundred (100) images. A user may want to identify images that have running containers based on a specific commit to a current git repository. In an exemplary embodiment, the user issues the command:
docker-search.py $(git rev-parse HEAD)
   The search application 101 may search the images themselves for objects that match the specified commit. Then, the search application 101 may, for each image found, evaluate associated objects and the relationships therebetween.

For example, the image search may yield the following two images:
afeoscyc-mw.cec.lab.emc.com/devops/alpine/kafka/2.1.0:dev-ballab1-mres3291
afeoscyc-mw.cec.lab.emc.com/devops/alpine/kafka/2.1.0:latest

The search application 101 may then traverse the linked list of objects for each image to identify running containers. For example, the additional searches may identify the following two running containers:
broker
zookeeper

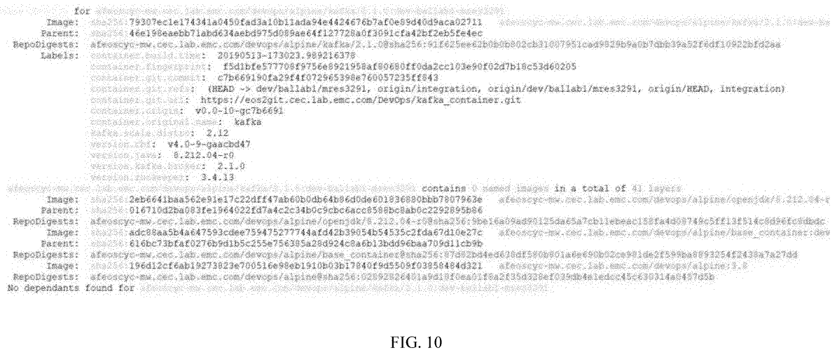

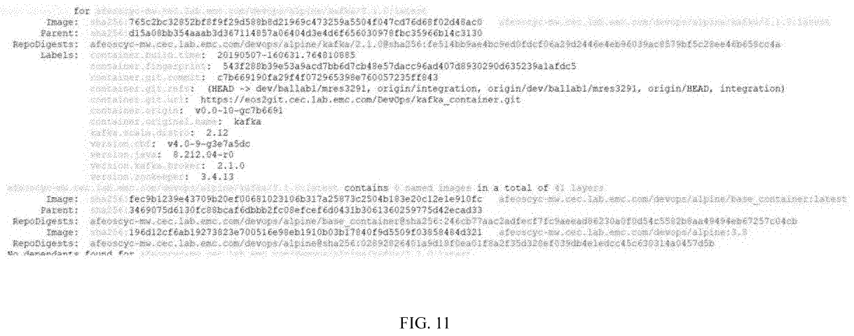

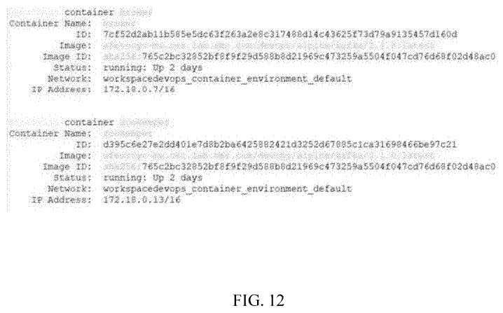

Next, the search application 101 may evaluate the relationships between the images and the running containers. The analysis may determine that the image “afeoscyc-mw.cec.lab.emc.com/devops/alpine/kafka/2.1.0:latest” includes both running containers. The search application 101 may aggregate information about the images and running containers and display them to the user. An exemplary display of relevant information is shown in FIGS. 10-12.

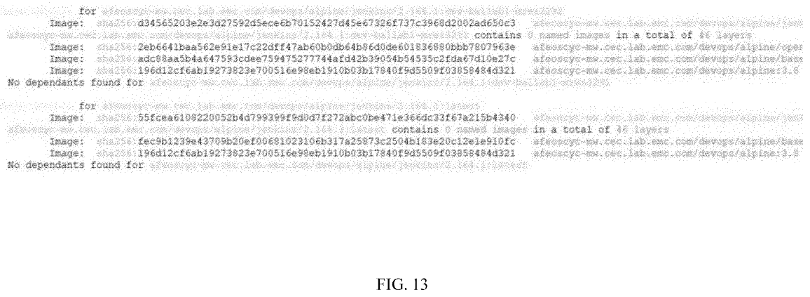

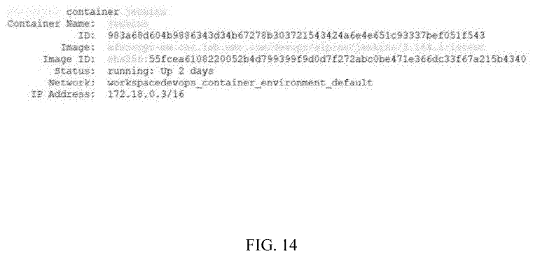

In another example, the docker system 100 includes more than one hundred (100) images. A recent build of the docker system includes images based on different versions of the image “alpine/openjdk”. To identify images based on the different versions, the user may issue the command:
docker-search.py-brief alpine/openjdk
   The search application 101 may search the images for those based on any version of “alpine/openjdk”, and return the following two images:
afeoscyc-mw.cec.lab.emc.com/devops/alpine/kafka/2.1.0:dev-ballab1-mres3291
afeoscyc-mw.cec.lab.emc.com/devops/alpine/kafka/2.1.0:latest
   The search application 101 may also search the containers for any container that was built on top of “alpine/openjdk”, and return the following container:
jenkins
   The search application 101 may aggregate information about the images and container and display them to the user. An exemplary display of relevant information is shown in FIGS. 13-14.

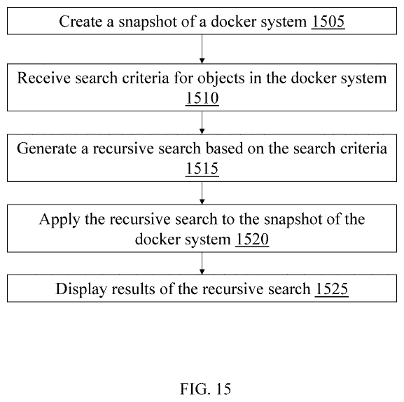

FIG. 15 depict a flow diagram for an exemplary method of searching a docker system. illustrating managing inline data compression and deduplication in a storage system. With reference also to FIGS. 1-2, in at least one embodiment of the current technique, an application creates a snapshot of the docker system (step 1505). The application receives search criteria for objects in the docker system (step 1510). The application generates a recursive search based on the search criteria (step 1515). The application applies the recursive search to the snapshot of the docker system (step 1520). The application displays results of the recursive search (step 1525).

It should again be emphasized that the implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method for searching a docker system, the method comprising:
creating, by an application executing on a computer system, a snapshot of the docker system;
receiving search criteria for objects in the docker system;
generating a recursive search based on the search criteria;
applying the recursive search to the snapshot of the docker system; and
displaying results of the recursive search.

2. The method of claim 1, wherein creating the snapshot of the docker system comprises:
requesting information about objects in a local docker subsystem.

3. The method of claim 2, wherein creating the snapshot of the docker system comprises:
requesting information about objects in a remote docker subsystem; and
creating the snapshot from the information about the objects in the local and remote docker subsystems.

4. The method of claim 1, wherein creating the snapshot of the docker system comprises:
requesting, via an application programming interface provided by a docker subsystem, information about the objects in the docker subsystem.

5. The method of claim 1, wherein receiving the search criteria for objects in the docker system comprises:
receiving the search criteria as plain text or a regular expression.

6. The method of claim 1, wherein generating a recursive search based on the search criteria comprises:
generating a recursive search for a type of object that meets the search criteria.

7. The method of claim 1, wherein applying the recursive search to the snapshot of the docker system comprises:
applying the recursive search to different types of objects in the docker system to identify a set of initial matches.

8. The method of claim 7, wherein applying the recursive search to the snapshot of the docker system further comprises:
cross-referencing each object in the set of initial matches to identify additional matches to the search criteria.

9. The method of claim 7, wherein applying the recursive search to the snapshot of the docker system further comprises:
evaluating objects related to each object in the set of initial matches according to the search criteria to find additional matches.

10. The method of claim 9, wherein evaluating the objects related to each object in the set of initial matches according to the search criteria comprises:
traversing, for each object in the set of initial matches, a linked list of objects to compare each linked object to the search criteria.

11. A system for use in searching a docker system, the system comprising a processor configured to:
create a snapshot of the docker system;
receive search criteria for objects in the docker system;
generate a recursive search based on the search criteria;
apply the recursive search to the snapshot of the docker system; and
display results of the recursive search.

12. The system of claim 11, wherein the processor is further configured to:
request information about objects in a local docker subsystem.

13. The system of claim 12, wherein the processor is further configured to:
request information about objects in a remote docker subsystem; and
create the snapshot from the information about the objects in the local and remote docker subsystems.

14. The system of claim 11, wherein the processor is further configured to:
request, via an application programming interface provided by a docker subsystem, information about the objects in the docker subsystem.

15. The system of claim 11, wherein the processor is further configured to:
receive the search criteria as plain text or a regular expression.

16. The system of claim 11, wherein the processor is further configured to:
generate a recursive search for a type of object that meets the search criteria.

17. The system of claim 11, wherein the processor is further configured to:
apply the recursive search to different types of objects in the docker system to identify a set of initial matches.

18. The system of claim 17, wherein the processor is further configured to:
cross-reference each object in the set of initial matches to identify additional matches to the search criteria.

19. The system of claim 17, wherein the processor is further configured to:
evaluate objects related to each object in the set of initial matches according to the search criteria to find additional matches.

20. The system of claim 19, wherein the processor is further configured to:
traverse, for each object in the set of initial matches, a linked list of objects to compare each linked object to the search criteria.
